(19) United States
(12) Patent Application Publication
(10) Pub. No.: US 2007/0143932 A1
(43) Pub. Date: Jun. 28, 2007

(54) Process for producing a fibre compositions

(76) Inventors: Johanna Buchert, Espoo (FI); Stina Gronqvist, Tolkkinen (FI); Liisa Viikari, Helsinki (FI); Anna Suurnakki, Espoo (FI); Hannu Mikkonen, Rajamaki (FI)

Correspondence Address: SUGHRUE MION, PLLC, 2100 PENNSYLVANIA AVENUE, N.W., SUITE 800, WASHINGTON, DC, 20037, US

(21) Appl. No.: 10/583,849

(22) PCT Filed: Dec. 23, 2004
(86) PCT No.: PCT/FI04/00793

§ 371 Date: Oct. 2, 2006

(30) Foreign Application Priority Data
Dec. 23, 2003 (FI) 20031901

(51) Int. Cl. C08F 251/02; D21H 11/20; H01B 1/12

(52) U.S. Cl. 8/116.1; 162/9; 162/157.6

(57) ABSTRACT

The present invention relates to fibre compositions. In particular, the present invention concerns a process for producing a fibre composition comprising a lignocellulosic fibre material and a synthetic, electrically conductive polymer formed by polymerized monomers. The invention provides for good adhesion between the fibre matrix and the polymer, because the monomer is polymerized directly on the fibre. The conductivity of the polymer is improved and the electrical properties and conductivity levels of the modified fibre can be adjusted by changing the amounts of the electrically conductive polymer.

### BACKGROUND OF THE INVENTION

1. Field of the Invention

The present invention relates to fibre compositions. In particular, the present invention concerns a process for producing a fibre composition comprising a lignocellulosic fibre material and a synthetic, electrically conductive polymer formed by polymerized monomers.

2. Description of Related Art

Fibre products comprising conductive polymers are known from several publications. They are used for a great variety of applications, ranging from security papers and insulating papers to antistatic clothes and foodstuff packages.

U.S. Pat. No. 5,421,959 discloses a composite that comprises paper and conjugated electroconducting polymer and the production process thereof. The paper is impregnated with a solution of a conjugated polymer and subjected to heat treatment. Such composites find use as electrodes for batteries, electrochemical sensors and electrochromic devices.

DE 19826800 discloses a specialty paper, with electrically conductive matter as an authentication mark, the conductive material being formed of pigments and/or transparent polymers. The pigments or polymers are added to the head box of the paper machine to form a homogenous mix with the furnish used for producing the paper material or they are homogeneously or partially spread over the paper web surface.

EP1090187 relates to marking materials and security markings and to a method for integrating these into the pulp line of documents, bond paper, banknotes, packaging and goods. The invention also relates to a method for testing electroconductive marking substances and security markings integrated in this way.

EP 1 139 710 discloses a wallpaper for shielding electromagnetic waves and for preventing static electricity. The wallpaper is prepared by applying a coating onto at least one surface of raw paper. As coating, a dispersion containing a conductive polymer material is used.

EP 0783015 discloses cellulose microfibrils coated with a polypyrrole conducting film, which is approximately 10-100 nm thick, and a process for the preparation thereof.

U.S. Pat. No. 5,336,374 discloses a composite comprising a paper and a conjugated electroconducting polymer, wherein the conjugated electroconducting polymer is located between the fibers or in close contact with fibers of the paper. A process for producing a composite, which comprises subjecting a conjugated compound to electropolymerization or oxidation polymerization in the presence of a paper, is also disclosed. The patent specification further teaches a process for producing a functional composite, which comprises impregnating a paper with a solution of a precursor polymer of a conjugated electroconducting polymer and heat-treating the paper to form a conjugated electroconducting polymer between or on surface of fibers of the paper.

U.S. Pat. No. 5,030,508 discloses fabrics that are made electrically conductive by contacting the fiber under agitation conditions with an aqueous solution of an aniline compound, oxidizing agent and a doping agent or counter ion and then depositing onto the surface of individual fibers of the fabric a prepolymer of the aniline compound so as to uniformly and coherently cover the fibers with a conductive film of the polymerized aniline compound and wherein, furthermore, the oxidizing agent is a vanadyl compound whereby the reaction rate is controlled such that the prepolymer is uniformly and coherently adsorbed onto the surface of the textile material, thereby providing improved films of electrically conductive polymerized compound on the textile material.

U.S. Pat. No. 4,521,450 discloses solid, impregnable materials, such as cellulose-based insulating materials, where the electrical conductivity can be increased by supplying to the solid impregnable material a substance with the ability to give a polymer with higher electrical conductivity than the solid impregnable material. This is achieved by polymerization of a pyrrole compound comprising at least one of the substances pyrrole and N-methylpyrrole, whereafter the pyrrole compound is transformed into a polymer in the solid, impregnable material.

U.S. Pat. No. 5,211,810 discloses a fibrous material useful for cooking food items in a microwave oven. The material is produced by suspending a fibrous material and a monomer precursor of a conductive polymer in an aqueous solution. Addition of a chemical oxidant induces polymerization of the monomer resulting in coating of the fibrous based material. Conductive polymer coated fibrous based materials can be formed into a paper product by conventional papermaking techniques or moulded into an integral structures having microwave interactive properties. The publication does not disclose the conductivity of fibres or products.

In prior art, the polymers are loosely attached to the fibre matrix. When the polymer is mixed with the fibres, adhesion is weak because polymers tend to be hydrophobic, whereas the fibres are hydrophilic. When a prepolymer impregnated into the fibre is polymerized, the polymerization takes place on the fibres, because the polymer is not capable of fully impregnating the fibre matrix. This means that a polymer layer is built on the fibres. The adhesion between the fibre layer and the polymer layer is weak. The polymer layer can easily disengage from the fibre matrix, which is a problem in several applications.

There is a need for a conductive fibre product, of the kind where the polymer attaches directly to the fibre matrix providing good adhesion between the two main components of composition. This is important from the point of view from the production process. There are also several applications that call for a conducting product with good adhesion between the components.

### SUMMARY OF THE INVENTION

It is an aim of the present invention to eliminate the problems of the prior art and to provide a novel fibre composition comprising a lignocellulosic fibre material and a synthetic, electrically conductive polymer, which is firmly attached to the fibre matrix.

The invention is based on the idea of producing conductive fibres by activating the fibres of the matrix with an oxidizing agent capable of oxidizing phenolic or similar structural groups before polymerising the conductive polymer in situ in the presence of the fibres. The activation is carried out either enzymatically or chemically by mixing the fibres with an oxidizing agent. The activated fibres are then contacted with a bifunctional agent, such as a monomeric substance, in the following also called a “modifying agent”. This bifunctional agent has at least two functional groups, where the first functional group(s) provides for binding of the modifying compound to the lignocellulosic fibre material, in particular at the oxidized phenolic or similar structural groups or corresponding chemical structures of the fibres, which have been oxidized during the activation step. The second functional group(s) of the bifunctional agent forms a binding surface or acts as a primer capable of binding a monomer of the polymeric material, which is to be attached to the fibre matrix. Once a primer has been formed onto the fibres of the matrix, the monomers of the conductive polymer are contacted with the primered fibres, and polymerization of the conductive polymer is carried out in a manner known per se. When a monomer is attached to the primer, the conductive polymer will be grafted onto the fibres, resulting in a conductive fibre matrix being formed.

According to the invention, the primer formed on the fibre provides for good adhesion of the fibre component and the polymer component with good conductivity.

Based on the above, the process according to the invention comprises the steps of
a) oxidizing the phenolic groups or groups having similar structure of the lignocellulosic fibre material to provide an oxidized fibre material,
b) contacting the oxidized fibre material with a bifunctional substance to provide a modified lignocellulosic fibre material capable of binding monomers of the conductive polymer, and
c) contacting the modified lignocellulosic fibre material with monomers of the conductive polymer under conditions conducive to polymerization to produce polymer chains of the synthetic, electrically conductive polymer, which are grafted to the surface of the lignocellulosic fibre material.

In particular, the phenolic groups of similar groups are oxidized by reacting the lignocellulosic fibre material with a substance capable of catalyzing the oxidation of the groups.

More specifically, the present invention is mainly characterized by what is stated in the characterizing part of claim 1.

The present invention provides important advantages. Firstly, the invention provides for good adhesion between the fibre matrix and the polymer, because the monomer is polymerized directly on the fibre. In the prior art, the polymer forms a layer on the fibres but is not chemically bound to the fibres. Furthermore, as mentioned above, the conductivity of the polymer is improved and the electrical properties and conductivity levels of the modified fibre can be adjusted by changing the amounts of the electrically conductive polymer.

It has been found that the amount of conductive polymer (based on the nitrogen content of treated pulp) grafted onto fibre surface can be increased by introducing a “primer” compound onto fibre in the first stage.

Further details and advantages of the invention will become apparent from the following detailed description comprising a number of working examples.

### DETAILED DESCRIPTION OF THE INVENTION

As mentioned above, the invention generally relates to a method of producing a fibre composition comprising a lignocellulosic fibre material containing phenolic or similar structural groups and a synthetic, electrically conductive polymer formed by polymerized, bifunctional monomers, according to which method the monomers are polymerized in the presence of the lignocellulosic fibre material to form a composition in which the polymer is bound to the fibres. According to the present invention, a new product is provided, which comprises chains of conductive polymer, which are grafted to a fibre matrix.

The fibre matrix comprises fibres containing phenolic or similar structural groups, which are capable of being oxidized by suitable enzymes or chemically. Such fibres are typically “lignocellulosic” fibre materials, which include fibre made of annual or perennial plants or wooden raw material by, for example, mechanical or chemimechanical pulping or by kraft pulping. During industrial refining of wood by, e.g., refiner mechanical pulping (RMP), pressurized refiner mechanical pulping (RMP), thermomechanical pulping (TMP), groundwood (GW) or pressurized groundwood (PGW) or chemithermomechanical pulping (CTMP), a woody raw material, derived from different wood species, is refined into fine fibres in processes which separate the individual fibres from each other. The fibres are typically split between the lamellas along the interlamellar lignin layer, leaving a fibre surface, which is at least partly covered with lignin or lignin-compounds having a phenolic basic structure.

Within the scope of the present invention chemical pulps are also included if they have a residual surface content of lignin sufficient to give at least a minimum amount of phenolic groups necessary for providing binding sites for the modifying agent. Generally, the concentration of lignin in the fibre matrix should be at least 0.1 wt-%, preferably at least about 1.0 wt-%.

In addition to paper and paperboard making pulps of the above kind, also other kinds of fibres of plant origin can be used, such as bagasse, jute, flax and hemp.

In the first stage of the present process, the lignocellulosic fibre material is reacted with a substance capable of catalyzing the oxidation of phenolic or similar structural groups to provide an oxidized fibre material. Typically, the substance capable of catalyzing oxidation is an enzyme. The enzymatic reaction is carried out by contacting the lignocellulosic fibre material with an oxidizing agent, which is capable—in the presence of the enzyme—of oxidizing the phenolic or similar structural groups to provide an oxidized fibre material. Such oxidizing agents are selected from the group of oxygen and oxygen-containing gases, such as air, and hydrogen peroxide. These can be supplied by various means, such as efficient mixing, foaming, gas enriched with oxygen or oxygen supplied by enzymatic or chemical means or chemicals releasing oxygen or peroxides to the solution. Hydrogen peroxide can be added in situ.

According to an embodiment of the invention, the oxidative enzymes capable of catalyzing oxidation of phenolic groups, are selected from, e.g. the group of phenoloxidases (E.C.1.10.3.2 benzenediol:oxygen oxidoreductase) and catalyzing the oxidation of o- and p-substituted phenolic hydroxyl and amino/amine groups in monomeric and polymeric aromatic compounds. The oxidative reaction leads to the formation of phenoxy radicals. Another groups of enzymes comprise the peroxidases and other oxidases. “Peroxidases” are enzymes, which catalyze oxidative reaction using hydrogen peroxide as their electron acceptor, whereas “oxidases” are enzymes, which catalyze oxidative reactions using molecular oxygen as their electron acceptor.

In the method of the present invention, the enzyme used may be for example laccase, tyrosinase, peroxidase or oxidase, in particular, the enzyme is selected the group of laccases (EC 1.10.3.2), catechol oxidases (EC 1.10.3.1), tyrosinases (EC 1.14.18.1), bilirubin oxidases (EC 1.3.3.5), horseradish peroxidase (EC 1.11.1.7), manganase peroxidase (EC 1.11.1.13), lignin peroxidase (EC1.11.1.14)

The amount of the enzyme is selected depending on the activity of the individual enzyme and the desired effect on the fibre. Advantageously, the enzyme is employed in an amount of 0.0001 to 10 mg protein/g of dry matter. Different dosages can be used, but advantageously about 1 to 100,000 nkat/g, preferably 10-500 nkat/g.

The activation treatment is carried out at a temperature in the range of 5 to 100° C., typically about 10 to 85° C. Normally, ambient temperature (room temperature) or a slightly elevated temperature (20-80° C.) is preferred. The consistency of the pulp is, generally, 0.5 to 95% by weight, typically about 1 to 50% by weight, in particular about 2 to 40% by weight. The pH of the medium is preferably slightly acidic, neutral or acidic, in particular the pH is about 2 to 10, in the case of phenoloxidases. Peroxidases are typically employed at pH of about 3 to 12. The reaction mixture is stirred during oxidation. Other enzymes can be used under similar conditions, preferably at pH 2-10.

According to another embodiment, the lignocellulosic fibre material is reacted with an chemical oxidizing agent capable of catalyzing the oxidation of phenolic or similar structural groups to provide an oxidized fibre material in the first stage of the process. The chemical oxidizing agent may be a typical, free radical forming substance as hydrogen peroxide, Fenton reagent, organic peroxidase, potassium permanganate, ozone and chlorine dioxide. Examples of suitable salts are inorganic transition metal salts, specifically salts of sulphuric acid, nitric acid and hydrochloric acid. Ferric chloride is an example of a suitable salt. Strong chemical oxidants such as alkali metal- and ammoniumpersulphates and organic and inorganic peroxides can be used as oxidising agents in the first stage of the present process. According to an embodiment of the invention, the chemical oxidants capable of oxidation of phenolic groups are selected from the group of compounds reacting by radical mechanism.

According to another embodiment, the lignocellulosic fibre material is reacted with a radical forming radiation capable of catalyzing the oxidation of phenolic or similar structural groups to provide an oxidized fibre material. Radical forming radiation comprises gamma radiation, electron beam radiation or any high energy radiation capable of forming radicals in a lignocellulose or lignin containing material.

Chemically the wood fibres can be activated by addition of radicalisation agents (e.g chemicals that cleave to form radicals). The activation treatment is carried out at a temperature in the range of 5 to 100° C., typically about 10 to 85° C. Ambient temperature (room temperature) or a slightly elevated temperature (20-80° C.) can be used. Normally, ambient temperature (+15 . . . +20° C.) or a lower temperature −10° C. . . . +15° C. is preferred.

Depending on the modifying agent or its precursor, the pH of the medium can be neutral or weakly alkaline or acidic (pH typically about 2 to 12). It is preferred to avoid strongly alkaline or acidic conditions because they can cause hydrolysis of the fibrous matrix. Normal pressure (ambient pressure) is also preferred, although it is possible to carry out the process under reduced or elevated pressure in pressure resistant equipment. Generally, the consistency of the fibrous material is about 0.5 to 50% by weight during the contacting stage.

In the second step of the process, a modifying agent is bonded to the oxidized phenolic or similar structural groups of the matrix to provide binding surfaces for the grafting polymer. Such a modifying agent typically exhibits at least two functional groups, a first group which is capable of contacting and binding with the oxidized phenolic or similar structural groups or to its vicinity, and a second group which is capable of bonding to the monomer of a conductive polymer. The term “bifunctional” is used to designate any compound having at least two functional groups or structures capable of achieving the above aim. Such functionalities include reactive groups, such as hydroxyl, carboxy, anhydride, aldehyde, ketone, amino, amine, amide, imine, imidine and derivatives and salts thereof, to mention some examples. The first and second functional groups can be identical or different. They are attached to a hydrocarbon residue, which can be a linear or branched aliphatic, cycloaliphatic, heteroaliphatic, aromatic or heteroaromatic. According to one preferred embodiment, aromatic compounds having 1 to 3 aromatic ring(s)—optionally forming a fused cyclic structure—are used. As a typical example, aminophenol can be mentioned, which contains a first functionality compatible with the oxidized phenolic structure (the phenolic hydroxyl group) and a second functionality compatible with the functional groups of the conductive polymer (the amino function).

The modifying agent can comprise a plurality of second functional groups.

According to one embodiment, the monomer of the conductive polymer (cf. below) is used as such as a bifunctional compound capable of attaching to the activated phenolic or similar structural groups of the fibre. Thus, the bifunctional compound can be, for example aniline, pyrrole or thiophene.

It is essential that modifying agent is bonded chemically, physically or by chemi- or physi-sorption to the fibre matrix to such an extent that at least an essential part of it cannot be removed. One criterion, which can be applied to test this feature, is washing in aqueous medium, because often the fibrous matrix will be processed in aqueous environment, and it is important that it retains the new and valuable properties even after such processing. Thus, preferably, at least 10 mole-%, in particular at least 20 mole-%, and preferably at least 30 mole-%, of the modifying agent remains attached to the matrix after washing or leaching in an aqueous medium.

According to another embodiment, the primer compounds can be introduced onto the fibre by using any known method reported in literature. Most favourably, the grafting of wood fibre or cellulose fibre is carried out by using radical mechanism. One example of effective radicalisation agent for wood fibre, cellulose or other polysaccharides is CAN (Cerium ammonium nitrate).

Phenolic compounds can also be linked to the fibre by using aldehydes or dialdehydes such as formaldehyde, paraformaldehyde, glyoxal or derivatives of them as a linking agent. Methylol or formyl derivatives of phenolic compounds and pyrrole can be used as well, just to mention some examples.

In the third step of the process, the modified fibre matrix is contacted with the monomers of the electrically conductive polymer, which are polymerized in such a way that one end of the polymer chain is attached to the primered matrix. The term “monomers” includes also short oligomers that can be polymerized to an electrically conductive polymer.

The electrical conductive polymer can be any suitable polymer, which can be rendered properties of electrical conductivity, e.g. by doping with a suitable doping agent. Within the scope of the present invention, the term “electrically conductive polymer” also includes polymers, which are non-conductive during the processing but which can be brought into conductive form by doping. The electrically conductive polymer can be selected from the group of polyaniline, polypyrrol, polyacetylene, polyparaphenylene and polythiophene and derivatives and mixtures thereof. The derivatives include alkyl and aryl derivatives of the afore-mentioned polymers as well as chlorine and bromine substituted derivatives.

Polymerization of the monomers can be carried out in the presence of an oxidizing agent, such as laccase. Other suitable oxidizing agents include conventional polymerization activators, such as multivalent metal salts, in particular ferric salts (e.g. FeCl₃), and percompounds, such as peroxides, peracids, persulphates, perborates, permanganates, and perchlorates. The weight ratio of the oxidizing agent to the monomeric component is generally about 10:1-1:10, typically a molar surplus of the oxidizing agent is used with respect to the monomer.

The modifying agent may be the same compound as the monomer of the electrically conductive polymer. The modifying agent may also be the same as the monomer of the electrically conductive polymer. Especially, when chemicals are used for the activation step, the modifying agent may be different than the monomer.

The electrically conducting polymers can be doped to render them the desired properties of conductivity. For example, an electrically neutral polyaniline can be brought into a conductive polyaniline complex by doping using known, acidic doping agents use for convering conjugated polymers into conductive or semiconductive form. Such agents include mineral acids, e.g. sulphuric acid and hydrochloric acid, and various organic sulphonic acids, such as DBSA and CSA, to mention some examples.

Polymerization is carried out in an aqueous medium. Typically, the consistency of the reaction mixture is about 0.1 to 50% by weight, in particular about 1 to 20% by weight. The temperature in the range of 0 to 100° C., typically about 10 to 85° C. Normally, ambient temperature (room temperature) or a slightly elevated temperature (20-80° C.) is preferred. Also temperatures below or at room temperature are preferred, a typical reaction temperature being below 35° C., preferably about 1 to 15° C. The pH of the aqueous medium is chosen as to favor polymerization. Typical pH values are in the acidic range, such a pH from 2 to 6.9, preferably from 2 to 4. Oxidants, such as persulfates and peroxides, can be used in the basic reaction medium at a pH of 4 to 14.

The above reaction and contacting steps can be carried out sequentially or simultaneously. According to a particularly preferred embodiment of the latter alternative, steps 1 to 3 are carried out simultaneously by forming in an aqueous medium a mixture of lignocellulosic fibres and the monomer, adding the enzyme, and oxidizing phenolic or similar structural groups on the lignocellulosic fibres while binding the monomers to the oxidized phenolic groups.

As a result of process according to the invention, a fibre matrix comprising a grafted polymer is obtained. The conductivity of the product can be freely varied depending on the desired application. Typical levels include 10⁴-10¹¹ ohm/m², advantageously 10⁴-10⁸ ohm/m². When the conductivity of the product is below 10¹¹ ohm, the product it is static dissipate and, when the conductivity is below 10⁵ ohm, it is electrically conducting.

The conducting or static product can easily be separated from the unconducting, insulative product. The conductive fibre product may perform several functions in several different end uses depending on the conductivity. The end uses may be anti-static products, security markings, biofuel cells storing information etc.

When fibres are treated according to the invention, the polymer is evenly distributed on the fibre. This means that the conductivity is evenly distributed throughout the fibre material and the fibre matrix. This is a clear advantage for several applications. Thus, an important advantage is that the conductivity of the product is retained through prolonged intervals.

As described in the working examples, a polyaniline content of 10 wt-% is enough to provide a conductive polymer with conductive properties up to the level of 10⁴ Ohm.

The fibres according to the invention can be used as such or mixed with another matrix material. A fibrous web may be formed of the fibres. The conducting fibres may find use when combined with other products such as paper, paperboard or other fibre products such as moulded products. Composite products together with different polymers and fillers can be formed. The invention also provides for manufacturing conductive boards that are identifiable by conductive measurements. This kind of boards may be useful in building industry.

The following non-limiting examples illustrate the invention.

### EXAMPLES

### Example 1

A chemo-enzymatic treatment was started by mixing 20 g TMP (pH ˜4.5) in mixer at a consistency of 16% at room temperature. Laccase (1000 nkat/g of pulp dry matter) was added. After 30 min reaction, an aqueous solution of 4-aminophenol, comprising 1.3 g aminophenol, 80 ml of acidic water, was added. The added amount of 4-aminophenol was equivalent to 0.6 mmol 4-aminophenol/g pulp. After the addition, the pulp was mixed for 2 h at a pulp consistency of 10 wt-%.

Throughout the following steps, the suspension was stirred:

290 ml of an aniline solution (containing 2 g of aniline and 17.2 g of DBSA) was added to the pulp suspension and 4.6 g of APS dissolved in water was added within 4 h. The pulp concentration was 3% after all additions. The pulp was additionally mixed for 12 h, thereafter the pulp was diluted to 2000 ml, filtered, washed with 400 ml of water.

After the treatments, handsheets were prepared from the pulps according to SCAN M5:76 on wire cloth. The handsheets were dried at room temperature. The surface resistivity of the handsheets was measured by using Premix SRM-110. The nitrogen content of the samples was analysed by the Kjeldahl method.

### Example 2

An enzymatic treatment similar to the one described in Example 1 was started by mixing 20 g of TMP (pH 4.5) in a mixer at a consistency of 16% at RT. Laccase (1000 nkat/g of pulp dry matter) was added. After 30 min reaction an aqueous solution of 4-aminophenol (1.3 g aminophenol, 80 ml acidic water was added (equivalent to 0.6 mmol 4-aminophenol/g pulp) and the pulp was mixed for 2 h. After the addition of the aminophenol solution, the pulp consistency was 10%. Then, the pulp was diluted to 2000 ml, filtered twice, and washed with 400 ml of water. Handsheets were prepared as in the previous example.

### Example 3

A chemical treatment was started by mixing 20 g of TMP, employed in an aqueous suspension at a consistency of 3 wt-%, with 290 ml of an aniline solution (containing 2 g of aniline and 17.2 g of DBSA). First, the aniline solution was added to the pulp suspension and then, during 4 h, 4.6 g of APS dissolved in water. After all additions, pulp consistency was 3%. The pulp was additionally mixed for 12 h, where after the pulp was diluted to 2000 ml, filtered twice, and washed with 400 ml of water. Handsheets were prepared as in the previous examples.

### Example 4

A chemo-enzymatic treatment similar to the one described in Example 1, was started by mixing 20 g of cold-disintegrated TMP (pH ˜4.5) in mixer at a consistency of 10% at RT. Laccase (1000 nkat/g of pulp dry matter) was added during this time. After 30 min reaction.

290 ml of an aniline solution (containing 2 g of aniline and 17.2 g of DBSA) was added to the pulp suspension and 4.6 g of APS dissolved in water was added within 4 h. The pulp concentration was 3% after all additions. The pulp was additionally mixed for 12 h, whereafter the pulp was diluted to 2000 ml, filtered twice, and washed with 400 ml of water. Handsheets were prepared as in the previous example.

### Example 5

A chemical treatment was started by mixing 20 g TMP (pH −4.5) in a mixer at a consistency of 17% for 10 minutes at RT. APS dissolved in water was added as an aerosol (0.075 g/g of pulp dry matter) during this time. An aqueous solution of 4-aminophenol (1.3 g aminophenol, 80 ml acidic waterl) was added (equivalent to 0.6 mmol 4-aminophenol/g pulp) and the pulp was mixed for 2 h. After the addition of the aminophenol solution, pulp consistency was 10%.

Throughout the following steps, the suspension was stirred:

Then, 290 ml of an aniline solution (containing 2 g of aniline and 17.2 g of DBSA) was admixed with the pulp suspension and 4.6 g of APS dissolved in water was added within 4 h. The pulp concentration was 3% after all additions. The pulp was additionally mixed for 12 h, whereafter the pulp was diluted to 2000 ml, filtered twice, and washed with 400 ml of water. Handsheets were prepared as in the previous examples.

The results of Examples 1 to 5 are summarized in Table 1 below:

TABLE 1

| | Nitrogen | Conductivity of handsheets |
|---|---|---|
| Treatment | (ppm) | prepared of the treated pulps |
| 1 | N(1): 1600 ppm; | 10 exp5 ohm/m² |
| | N(2): 1400 ppm | |
| 2 | 1300 | 10exp9-10 ohm/m² |
| 3 | 700 | 10exp9-10 ohm/m² |
| 4 | 4200 | 10exp9 ohm/m² |
| 5 | 1100 | 10 exp5 ohm/m² |

TMP = thermomechanical pulp
APS = ammonium peroxy sulphate (chemical oxidizing agent)

As apparent from the above, by bonding with a primer (in the examples, the aminophenol compound) to a lignocellulosic material (in the examples, the thermomechanical pulp fibre material, TMP), polymerisation of aniline on the surface of fibres can be conducted in such a way that a conductive material is formed.

The above results show also that enzymatic activation (in this case with laccase) leads to bonding of more aniline to the fibres than without the activation.

Similar results were obtained with other oxidative enzymes.

1. A process for producing a fibre composition comprising a lignocellulosic fibre material containing phenolic or similar structural groups, and a synthetic, electrically conductive polymer formed by polymerized monomers, according to which process the monomers are polymerized in the presence of the lignocellulosic fibre material to form a composition in which the polymer is bound to the fibres, characterized by
a) oxidizing the phenolic groups or the groups having a similar structure to provide an oxidized fibre material,
b) contacting the oxidized fibre material with a bifunctional substance to provide a modified lignocellulosic fibre material capable of binding monomers of the conductive polymer, and
c) contacting the modified lignocellulosic fibre material with monomers of the conductive polymer under conditions conducive to polymerization to produce polymer chains of the synthetic, electrically conductive polymer, which are grafted to the surface of the lignocellulosic fibre material.

2. The process according to claim 1, wherein the oxidized fibre material is contacted with the bifunctional monomers of the synthetic, electrically conductive polymer in order to bind the monomers to the surface of the oxidized lignocellulosic fibre material, to provide a modified lignocellulosic fibre material having monomers bound to its surface, and the modified lignocellulosic fibre material is contacted with the monomers to produce polymer chains of the synthetic, electrically conductive polymer, which are grafted to the surface of the lignocellulosic fibre material.

3. The process according to claim 1, wherein the modifying agent is activated with an oxidizing agent.

4. The process according to claim 1, wherein the lignocellulosic fibrous matrix is reacted with an oxidizing agent in the presence of a substance capable of catalyzing the oxidation of phenolic groups or groups having a similar structure by said oxidizing agent.

5. The process according to claim 1, wherein the reaction of step (a) is carried out in an aqueous phase at a consistency of about 1 to 95% by weight of the fibre material.

6. The process according to claim 1, wherein the polymer is selected from the group of polyaniline, polypyrrole, polythiophene and polyacetylene and derivatives thereof.

7. The process according to claim 1, wherein the bifunctional substance has at least two functional groups, where the first functional group participates in the binding of the modifying compound to the lignocellulosic fibre material and the second functional group forms a primer for binding to the polymeric material.

8. The process according to claim 7, wherein the modifying agent comprises at least one phenolic hydroxyl or similar structural group as a first functional group.

9. The process according to 7, wherein the second functional group is selected from the group of hydroxy, carboxy, anhydride, aldehyde, ketone, amine, amide, imine, imidine and derivatives and salts thereof.

10. The process according to claim 7, wherein the modifying agent comprises a plurality of second functional groups.

11. The process according to claim 1, wherein the bifunctional substance and the monomer are different.

12. The process according to claim 1, wherein the bifunctional substance and the monomer are the same.

13. The process according to claim 1, wherein the fibres are selected from lignocellulosic fibres produced by mechanical, chemimechanical or chemical pulping.

14. The process according to claim 4, wherein the substance capable of catalyzing the oxidation of phenolic or similar structural groups to provide an oxidized fibre material is an enzyme.

15. The process according to claim 1, wherein steps (a) to (c) are carried out simultaneously by forming in an aqueous medium a mixture of lignocellulosic fibres and the monomer, oxidizing phenolic or similar structural groups on the lignocellulosic fibres while binding the monomers to the oxidized phenolic or similar structural groups.

16. The process according to claim 15, wherein the enzyme is added to the aqueous medium in order to oxidized the phenolic or similar structural groups.

17. The process according to claim 14, wherein the enzyme capable of catalyzing the oxidation of phenolic groups is selected from the group of peroxidases and oxidases.

18. The process according to claim 17, wherein the enzyme is selected the group of laccases (EC 1.10.3.2), catechol oxidases (EC 1.10.3.1), tyrosinases (EC 1.14.18.1), bilirubin oxidases (EC 1.3.3.5), horseradish peroxidase (EC 1.11.1.7).

19. The process according to claim 17, wherein the enzyme dosage is from about 1 to 100,000 nkat/g, preferably 10-500 nkat/g, and it is employed in an amount of 0.0001 to 10 mg protein/g of dry matter.

20. The process according to claim 19, wherein the enzyme treatment is carried out at a temperature of 5-100° C., preferably 10-85° C. and most preferably at 20-80° C. and pH 3-12.

21. The process according to claim 3, wherein the oxidizing agent is selected from the group of oxygen and oxygen-containing gases, such as air and hydrogen peroxide.

22. The process according to claim 21, wherein oxygen or oxygen-containing gas or hydrogen peroxide is introduced into the aqueous slurry during the reaction.

23. The process according to claim 1, wherein a chemical oxidizing agent is used.

24. The process according to claim 22, wherein the chemical oxidizing agent is hydrogen peroxide, Fenton reagent, potassium permanganate, ozone and chloride dioxide or an inorganic transition metal salt, ammoniumperoxy sulphate

25. The process according to claim 1, wherein radical forming radiation capable of catalyzing the oxidation of phenolic or similar structural groups is used to provide an oxidized fibre material.

26. The process according to claim 1, wherein the reaction steps are carried out sequentially or simultaneously.
